(19) United States
(12) Patent Application Publication
(10) Pub. No.: US 2024/0062222 A1
(43) Pub. Date: Feb. 22, 2024

(54) METHOD, APPARATUS AND DEVICE FOR AUDITING DATA BASED ON BLOCKCHAIN, AND STORAGE MEDIUM

(71) Applicant: SHANGHAI NANOJCLEAN TECHNOLOGY CO., LTD., Shanghai (CN)

(72) Inventors: Chongyi ZHANG, Shanghai (CN); Jianliang GU, Shanghai (CN)

(21) Appl. No.: 18/266,943

(22) PCT Filed: Oct. 18, 2021
(86) PCT No.: PCT/CN2021/124357

§ 371 Date: Jun. 13, 2023

(30) Foreign Application Priority Data
Dec. 23, 2020 (CN) 202011551212.0

(51) Int. Cl. G06Q 30/018

(52) U.S. Cl. CPC G06Q 30/018; G06Q 2220/00

(57) ABSTRACT

A method, an apparatus, and a device for auditing data based on a blockchain, and a storage medium. The method includes: receiving, from a requester, an audit request including a type of the requester; determining an item to be audited, according to the type of the requester; generating an item for display, according to the item to be audited and an item for distraction; receiving first original data, which is inputted by the requester based on the item for display; generating a first audit result according to target data and an audit template, where the target data is in the first original data and corresponds to the item to be audited, and the audit template is generated based on the item to be audited and includes referential data for the item to be audited; and uploading the first original data and the first audit result to the blockchain.

The present disclosure claims the priority to Chinese Patent Application No. 202011551212.0, titled “METHOD, APPARATUS AND DEVICE FOR AUDITING DATA BASED ON BLOCKCHAIN, AND STORAGE MEDIUM”, filed on Dec. 23, 2020 with the China National Intellectual Property Administration, the content of which is incorporated herein by reference.

### FIELD

The present disclosure relates to the technical field of blockchains, and in particular to a method, an apparatus, and a device for auditing data based on a blockchain, and a storage medium.

### BACKGROUND

Currently, an enterprise should commission an audit to an auditing institution, to guarantee production and operation of the enterprise compliant with relevant regulations. For example, the auditing institution audits data that is related to production and operation and provided by the enterprise, and accordingly generates an audit result.

In conventional technology, the auditing institution notifies in advance the enterprise of a key item that is to be audited. For example, the to-be-audited items of the hotel may include elevators, room hygiene, air conditioning, and the like. Auditors from the auditing institution need to visit the hotel for auditing such items, which elongate a period of the audit. Moreover, preliminary notification of key items reduces credibility of the audit result. In addition, some dishonest enterprises would seek more profits by tampering with the audit result issued by the auditing institution, which further impairs the credibility of the audit result.

Therefore, there is an urgent need for an auditing method having a short auditing period and high reliability.

### SUMMARY

In order to address the above technical issue, a method, an apparatus and a device for auditing data based on a blockchain, and a storage medium are provided according to embodiments of the present disclosure, which can shorten a period of an audit and improve credibility of a result of the audit.

Following technical solutions are provided according to embodiments of the present disclosure.

In a first aspect, a method for auditing data based on a blockchain is provided according to embodiments of the present disclosure. The method includes: receiving an audit request from a requester, where the audit request includes a type of the requester; determining an item to be audited, according to the type of the requester; generating an item for display, according to the item to be audited and an item for distraction; receiving first original data, which is inputted by the requester based on the item for display; generating a first audit result according to target data and an audit template, where the target data is in the first original data and corresponds to the item to be audited, and the audit template is generated based on the item to be audited and includes referential data for the item to be audited; and uploading the first original data and the first audit result to the blockchain.

In an embodiment, determining the item to be audited according to the type of the requester includes: determining a weight for each of multiple candidate items, according to the type of the requester; and determining, among the multiple candidate items, a candidate item having the weight greater than a preset threshold, as the item to be audited.

In an embodiment, the method further includes: receiving data of a display page from the requester, where the data of the display page includes a second audit result, second original data, and description information, which are configured by the requester; generating a third audit result for the data of the display page according to the second audit result, the second original data, and the description information; generating a tag for the data of the display page, in response to the third audit result indicating that the data of the display page passes an audit, where the tag is configured to uniquely identify the data of the display page; and uploading the data of the display page and the tag to the blockchain.

In an embodiment, generating the third audit result for the data of the display page data according to the second audit result, the second original data, and the description information includes: generating the third audit result according to the second original data and the description information, in response to the first audit result that is in the blockchain and corresponds to the second original data is consistent with the second audit result; or generating the third audit result according to the second original data and the description information, in response to the first original data that is in the blockchain and corresponds to the second audit result is consistent with the second original data.

In an embodiment, the data of the display page further includes a blockchain record configured by the requester, and the blockchain record is configured to describe the first original data and the first audit result that have been uploaded to the blockchain. Before generating the third audit result for the data of the display page according to the second audit result, the second original data, and the description information, the method further includes: determining that the second original data and the second audit result are consistent with the first original data and the first audit result, respectively, which are described in the blockchain record.

In an embodiment, the method further includes: receiving from the requester a request for data update, where the request includes updated data, and the updated data includes at least one of: data of the display page that is updated, the first original data that is updated, or the second original data that is updated; generating an updated audit result based on the updating data request; and uploading the updated audit result and the updated data to the blockchain.

In a second aspect, an apparatus for auditing data based on a blockchain is provided according to embodiments of the present disclosure. The apparatus includes a receiving module, a processing module and an uploading module.

The receiving module is configured to receive an audit request from a requester, where the audit request includes a type of the requester.

The processing module is configured to: determine an item to be audited, according the type of the requester; and generate an item for display, according to the item to be audited and an item for distraction. The receiving module is further configured to receive first original data, which is inputted by the requester based on the item for display. The processing module is further configured to generate a first audit result according to target data and an audit template, where the target data is in the first original data and corresponds to the item to be audited, and the audit template is generated based on the item to be audited and includes referential data for the item to be audited.

The uploading module is configured to upload the first original data and the first audit result to a blockchain.

In an embodiment, the processing module is configured to: determine a weight for each of multiple candidate items, according to the type of the requester; and determine, among the multiple candidate items, a candidate item having the weight greater than a preset threshold, as the item to be audited.

In an embodiment, the receiving module is further configured to receive data of a display page from the requester, where the data of the display page includes a second audit result, second original data, and description information, which are configured by the requester. The processing module is further configured to: generate a third audit result for the data of the display page according to the second audit result, the second original data, and the description information; and generate a tag for the data of the display page, in response to the third audit result indicating that the data of the display page passes an audit, where the tag is configured to uniquely identify the data of the display page. The uploading module is further configured to upload the data of the display page and the tag to the blockchain.

In an embodiment, the processing module is configured to: generate the third audit result according to the second original data and the description information, in response to the first audit result that is in the blockchain and corresponds to the second original data is consistent with the second audit result; or generate the third audit result according to the second original data and the description information, in response to the first original data that is in the blockchain and corresponds to the second audit result is consistent with the second original data.

In an embodiment, the data of the display page further includes a blockchain record configured by the requester, and the blockchain record is configured to describe the first original data and the first audit result that have been uploaded to the blockchain. The processing module is further configured to: determine that the second original data and the second audit result are consistent with the first original data and the first audit result, respectively, which are described in the blockchain record.

In an embodiment, the receiving module is further configured to receive from the requester a request for data update, where the request includes updated data, and the updated data includes at least one of: data of the display page that is updated, the first original data that is updated, or the second original data that is updated. The processing module is further configured to generate an updated audit result based on the updating data request. The uploading module is further configured to upload the updated audit result and the updated data to the blockchain.

In a third aspect, a device for auditing data based on a blockchain is provided according to embodiments of the present disclosure. The apparatus includes a memory and a processor. The memory is configured to store a computer program and transmit the computer program to the processor. The processor is configured to perform any foregoing method according to the first aspect according to instructions in the computer program.

In a fourth aspect, a computer-readable storage medium is provided according to embodiments of the present disclosure. The computer-readable storage medium is configured to store computer software instructions. The computer software instructions when executed on a computer configure the computer to perform any forgoing method according to the first aspect.

The above technical solutions of the present disclosure have at least following advantages.

The method for auditing data is provided according to embodiments of the present disclosure. In the method, the requester may transmit the request for auditing service to an auditing institution, via an intelligent terminal (such as a mobile phone). Auditors in the auditing institution are not necessary to perform on-site auditing for the requester, thereby shortening a period of an audit. In such method, the item to be audited is determined according to the type of the requester, which is carried in the audit request, and the item for distraction is mixed with the item to be audited, so as to generate the item for display. In the method, the item for display is presented to the requester, and the requester inputs the original data based on the item for display. The requester is not aware of the key item to be audited by the auditing institution, thereby improving credibility of the audit result. In the method, the audit template is automatically generated according to the item to be audited. The audit template includes the referential data for the item to be audited. Hence, the target data that is in the original data and corresponds to the item to be audited may be imported into the audit template, and the audit result for the target data is generated from the audit template. Thereby, workload of the auditors is reduced, and efficiency of the audit is improved. In the method, the audit result is uploaded to the blockchain, and it is capable to verify through the audit result stored in the blockchain whether the requester tampers with the audit result. Thereby, credibility of the audit result is further improved.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques. Apparently, the drawings in the following descriptions are only some embodiments of the present disclosure, and other drawings may be obtained by those skilled in the art based on the provided drawings without creative efforts.

FIG. 1 is a diagram of system framework of an auditing system according to an embodiment of the present disclosure;

FIG. 2 is a schematic diagram of a main interface of an interaction subsystem according to an embodiment of the present disclosure;

FIG. 3 is a schematic diagram of an input interface according to an embodiment of the present disclosure;

FIG. 4 is a schematic diagram of an interface for submitting a display page according to an embodiment of the present disclosure;

FIG. 5 is a flow chart of a method for auditing data according to an embodiment of the present disclosure; and

FIG. 6 is a flow chart of a method for auditing data according to another embodiment of the present disclosure.

### DETAILED DESCRIPTION

In order to help those skilled in the art better understand solutions of the present disclosure, hereinafter technical solutions in embodiments of the present disclosure are described clearly and completely in conjunction with the drawings in embodiments of the present closure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

In order to facilitate understanding of those skilled in the art, hereinafter introduced are technical terms involved in the present disclosure.

Data audit refers to that an auditor audits data provided by a requester. For example, in auditing business, an auditor need audit data that is related to production and operation and provided by an enterprise, so as to guarantee production and operation of the enterprise compliant with relevant regulations.

In a conventional solution, the auditor notifies in advance the enterprise of a key item that is to be audited, which reduces credibility of the audit result. In addition, the auditors need visit the enterprise to collect relevant data on-site, and then audit such data, which elongate a period of the audit. Further, an enterprise may tamper with the audit result to seek more profit. For example, the enterprise may alter the audit result from “fail” to “pass”, and use raw materials not audited by an auditing institution in production or operation. In such case, product data provided by the enterprise and an audit result provided by the auditing institution are not reliable when determining a party who is accountable for a safety issue of a product, which further reduces the credibility of the auditing institution.

In view of the above, a method for auditing data based on a blockchain is provided according to embodiments of the present disclosure. The method may be implemented through an auditing system. In one embodiment, the auditing system receives an audit request transmitted from a requestor. The audit request includes a type of the requester, and the auditing system determines an item to be audited according to the type of the requester. Such item is a key item that is to be audited by the auditing institution. The auditing system mixes one or more items for distractions with the item to be audited, to generate an item for display. For example, the item for distraction may look similar to the item to be audited, but is not so relevant to key factors in the audit, so that the requester is not aware of the key item to be audited. Afterwards, the auditing system receives first original data, which is inputted by the requester based on the item for display, and then generates a first audit result according to target data and an audit template. The target data is in the first original data and corresponds to the item to be audited. The audit template is generated based on the item to be audited, and includes referential data for the item to be audited. The auditing system uploads the first original data and the first audit result to the blockchain, so as to provide a strong basis for verifying the first original data or the first audit result.

In the method, the requester may transmit the request for auditing service to an auditing institution, via an intelligent terminal (such as a mobile phone). Auditors in the auditing institution are not necessary to perform on-site auditing for the requester, thereby shortening a period of an audit. In such method, the item to be audited is determined according to the type of the requester, which is carried in the audit request, and the item for distraction is mixed with the item to be audited, so as to generate the item for display. In the method, the item for display is presented to the requester, and the requester inputs the original data based on the item for display. The requester is not aware of the key item to be audited by the auditing institution, thereby improving credibility of the audit result. In the method, the audit template is automatically generated according to the item to be audited. The audit template includes the referential data for the item to be audited. Hence, the target data that is in the original data and corresponds to the item to be audited may be imported into the audit template, and the audit result for the target data is generated from the audit template. Thereby, workload of the auditors is reduced, and efficiency of the audit is improved. In the method, the audit result is uploaded to the blockchain, and it is capable to verify through the audit result stored in the blockchain whether the requester tampers with the audit result. Thereby, credibility of the audit result is further improved.

The auditing system may be deployed in a computing device as computer software, to implement a function of data audit. In some embodiments, the auditing system may be a hardware system. The hardware system includes a physical device having a function of data audit.

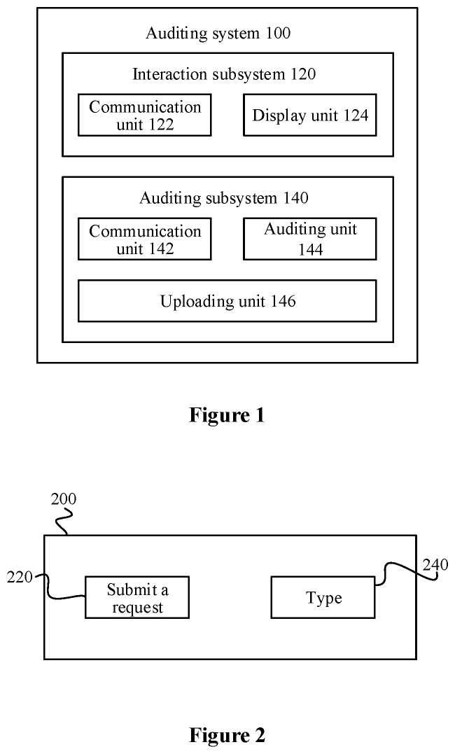

Hereinafter illustrated is system framework of an auditing system according to an embodiment of the present disclosure. As shown in FIG. 1, an auditing system 100 includes an interaction subsystem 120 and an auditing subsystem 140. The interaction subsystem is configured to provide a graphical user interface (GUI) for a requester, receive an audit request from the requester via the GUI, and receive first original data inputted by the requester. The auditing subsystem 140 is configured to determine an item to be audited according to a type of the requester, generate an item for display according to the item to be audited and an item for distraction, generate a first audit result according to target data, which is in the first original data and corresponds to the item to be audited, and an audit template, and then upload the first audit result and the first original data to a blockchain.

The interaction subsystem 120 includes a communication unit 122 and a display unit 124. The auditing subsystem 140 includes a communication unit 142, an auditing unit 144, and an uploading unit 146. Hereinafter these units are illustrated.

The communication unit 122 is configured to receive the audit request from the requester. For example, the communication unit 122 receives the audit request from the requester via the GUI. The audit request includes the type of the requester. The display unit 124 is configured to provide the GUI. Reference is made to FIG. 2, which is a schematic diagram of a main interface of an interaction subsystem according to an embodiment of the present disclosure. As shown in FIG. 2, the main interface 200 provides a request control 220 and a type control 240. The requester may select or input the type of the requester via the type control 240, and then transmit the audit request via the request control 220. After receiving the audit request from the requester, the communication unit 122 transmits the type of the requester to the auditing subsystem 140.

The auditing unit 144 determines the item to be audited according to the type of the requester transmitted by the interaction subsystem 120, and generates the item for display according to the item to be audited and the item for distraction. For example, one or more items for distractions are mixed with the item to be audited, to generate the item for display. The communication unit 142 transmits the item for display to the interaction subsystem 120.

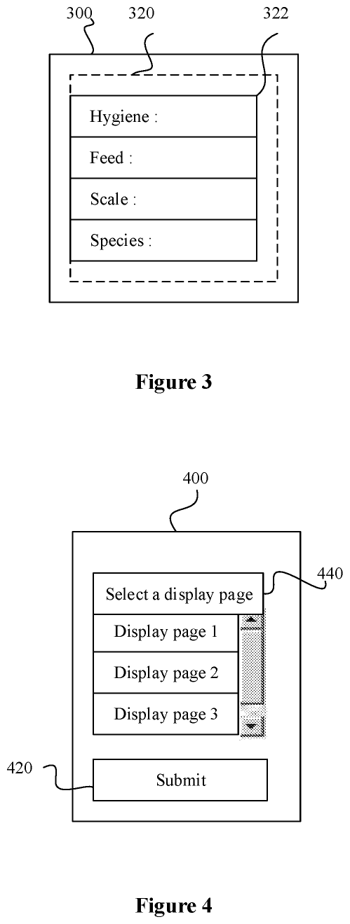

After the communication unit 122 receives the item for display transmitted by the auditing subsystem 140, the display unit 124 is further configured to provide an interface for inputting original data. Reference is made to FIG. 3, which is a schematic diagram of an input interface according to an embodiment of the present disclosure. An input interface 300 includes an input component 320. The input component 320 includes multiple items 322, so that the requester may input the first original data through the input component 320. The communication unit 122 is further configured to transmit the first original data to the auditing subsystem 140.

After receiving the first original data, the auditing subsystem 140 determines the target data and the audit template, to generate the first audit result. The target data is in the first original data and corresponds to the item to be audited. The audit template is generated based on the item to be audited and includes the referential data for the item to be audited. The uploading unit 146 is configured to upload the first audit result and the first original data to the blockchain.

In some embodiments, the auditing unit 144 determines a weight for each of multiple candidate items, according to the type of the requester, and determines, among the multiple candidate items, a candidate item having the weight greater than a preset threshold, as the item to be audited. The weight is determined according to the type of the requester and a degree of an impact of the corresponding candidate item on the requester. For example, the candidate item would have a higher weight in case of having a greater impact on the requester, and have a lower weight in case of having a smaller impact on the requester. Hence, the auditing unit 144 may audit only a part of the candidate items, which improves the auditing efficiency.

In some embodiments, the communication unit 122 is configured to receive data of a display page from the requester. The data of the display page includes a second audit result configured by the requester, second original data configured by the requester, and description information configured by the requester. The display unit 124 is further configured to provide an interface for submitting the display page. Reference is made to FIG. 4, which is a schematic diagram of an interface for submitting a display page according to an embodiment of the present disclosure. An interface 400 includes a submission control 420 and a selection control 440. The requester may browse and determine a to-be-audited display page through the selection control 440, and then submit the to-be-audited display page through the submission control 420. The communication unit 122 is further configured to transmit the data of the display page to the auditing subsystem 140.

The communication unit 142 is configured to receive the data of the display page from the interaction subsystem 120. The auditing unit 144 is configured to generate a third audit result for the data of display page according to the second audit result, the second original data, and the description information. The description information may be information for introduction. For example, the description information for a product may be an introduction to the product. The auditing unit 144 is further configured to generate a tag for the data of the display page, in response to the third audit result indicating that the data of the display page passes an audit. The tag is configured to uniquely identify the data of the display page. For example, the tag may be a two-dimensional code, a barcode, or the like. The display page may be obtained by scanning the two-dimensional code or the barcode via a terminal device. Since each tag identifies data of a display page uniquely, a quantity of the generated tags is equal to a quantity of the display pages. Hence, the auditing system 100 has a good control on the quantity of the display pages that have been audited and the quantity of the tags. The uploading unit 146 is further configured to upload the data of the display page and the tag to the blockchain.

In some embodiments, the auditing unit 144 is further configured to determine the first audit result, which is in the blockchain and corresponds to the second original data, according to the second original data configured by the requester. In a case that the first audit result is consistent with the second audit result configured by the requester, it indicates that the requester does not tamper with the first original data or the first audit result. In other embodiments, the auditing unit 144 is further configured to determine the first original data, which is in the blockchain and corresponds to the second audit result, according to the second audit result configured by the requester. In a case that the first original data is consistent with the second original data configured by the requester, it indicates that the requester does not tamper with the first original data or the first audit result.

Afterwards, the third audit result is generated for the data of the display page according to the second original data and the description information that are configured by the requester. The description information corresponds to the second original data. For example, the description information may be a part of the second original data, or may be the second original data expressed in another form. For example, the description information may be in a form of text or a table.

In some embodiments, the data of the display page further includes a blockchain record configured by the requester. The blockchain record is configured to describe the first original data and the first audit result that have been uploaded to the blockchain. The auditing unit 144 is further configured to audit the blockchain record. In on embodiment, the auditing unit 144 is configured to determine whether the first original data described by the blockchain record is consistent with the second original data configured by the requester, and determine whether the first audit result described by the blockchain record is consistent with the second audit result configured by the requester. The data of the display page passes the audit in a case that both determinations are positive, and fails the audit in a case that either determination is negative.

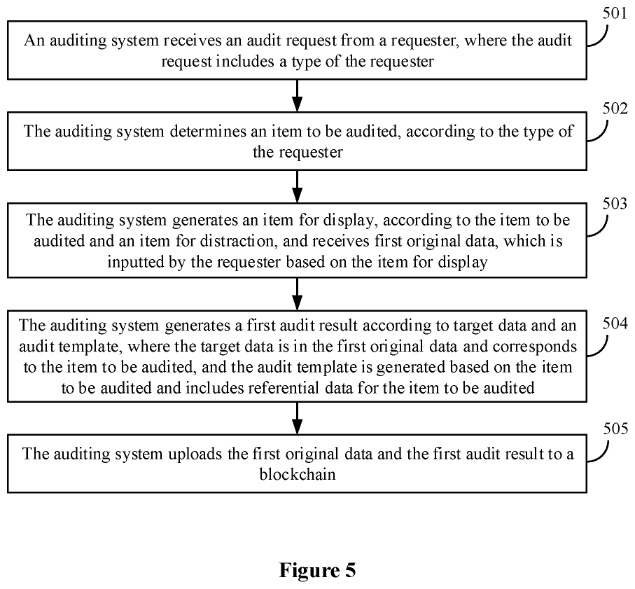

Hereinabove introduce is the auditing system 100, and hereinafter a method for auditing data is described in an embodiment from a perspective of the auditing system 100. Reference is made to FIG. 5, which is a flow chart of a method for auditing data according to an embodiment of the present disclosure. The method includes following steps S501 to S505.

In step S501, the auditing system 100 receives an audit request from a requester. The audit request includes a type of the requester.

In some embodiments, the auditing system 100 may receive the audit request from the requester via a GUI. The requester may submit the type of the requester in the audit request when transmitting the audit request, so that the auditing system 100 can receive the type of the requester. In other embodiments, the auditing system 100 may determine the type of the requester automatically according to a name of the requester. The present disclosure is not limited to the above manners, and those skilled in the art may select a manner according to actual requirements.

In step S502, the auditing system 100 determines an item to be audited, according to the type of the requester.

After receiving the type of the requester, the auditing system 100 is required to determine the item to be audited according to the type of the requester. In some embodiments, the auditing system 100 determines a weight for each of multiple candidate items, according to the type of requester, and determines a candidate item having a weight greater than a preset threshold among the multiple candidate items, as the item to be audited. The weight is determined according to the type of the requester and a degree of an impact of the candidate item on the requester. For example, the candidate item has a greater weight in case of a greater impact on the requester, and has a smaller weight in case of a smaller impact on the requester.

Hereinafter requesters of different types are illustrated as examples. In a process of an audit, a requester A is a hotel and a requester B is a farm. Multiple candidate items determined for the requestor A may include items concerning hygiene, elevators, lamps, and windows. The item concerning hygiene is more important among the multiple candidate items, and thus serves as the item to be audited in the audit. Multiple candidate items determined for the requestor B may include items concerning hygiene, breeding scales, feeds, and animal species. The items concerning feeds and hygiene are more important among the multiple candidate items, and thus both serve as the item to be audited in the audit.

In step S503, the auditing system 100 generates an item for display according to the item to be audited and an item for distraction, and receives first original data, which is inputted by the requester based on the item for display.

The requester would be aware of the key item in the audit in a case that being notified of the item to be audited. Therefore, the auditing system 100 mixed one or more items for distractions with the item to be audited, so as to confuse the requester. Taking the forgoing hotel case as an example, after determining the hygiene as the item to be audited, the auditing system 100 adds the item for distraction, such as items concerning time and re-cleaning. The item concerning time indicates time consumed by cleaning a room, and the item concerning re-cleaning indicates whether a room is cleaned again when unoccupied for a preset period.

After the auditing system 100 generates the item for display according to the item to be audited and the item for distraction, the requester may input the first original data according to the item for display.

In step S504, the auditing system 100 generates a first audit result according to target data and an audit template. The target data is in the first original data and corresponds to the item to be audited. The audit template is generated based on the item to be audited and includes referential data for the item to be audited.

The auditing system 100 determines the target data, which is in the first original data and corresponds to the item to be audited, according to the first original data, and then generates the first audit result according to the target data and the audit template. The audit template is generated based on the item to be audited, and includes the referential data for the item to be audited.

Since the audit template is generated based on the item to be audited, the target data that is in the first original data and corresponds to the item to be audited can be referred to the audit template for auditing. The auditing system 100 refers the first original data, which is inputted by the requester, directly to the audit template, and thereby generates the first audit result.

In step S505, the auditing system 100 uploads the first original data and the first audit result to a blockchain.

After generating the first audit result, the auditing system 100 uploads the first original data and the first audit result to the blockchain.

In this embodiment, the requester may transmit the request for auditing service to an auditing institution, via an intelligent terminal (such as a mobile phone). Auditors in the auditing institution are not necessary to perform on-site auditing for the requester, thereby shortening a period of an audit. In such method, the item to be audited is determined according to the type of the requester, which is carried in the audit request, and the item for distraction is mixed with the item to be audited, so as to generate the item for display. In the method, the item for display is presented to the requester, and the requester inputs the original data based on the item for display. The requester is not aware of the key item to be audited by the auditing institution, thereby improving credibility of the audit result. In the method, the audit template is automatically generated according to the item to be audited. The audit template includes the referential data for the item to be audited. Hence, the target data that is in the original data and corresponds to the item to be audited may be imported into the audit template, and the audit result for the target data is generated from the audit template. Thereby, workload of the auditors is reduced, and efficiency of the audit is improved. In the method, the audit result is uploaded to the blockchain, and it is capable to verify through the audit result stored in the blockchain whether the requester tampers with the audit result. Thereby, credibility of the audit result is further improved.

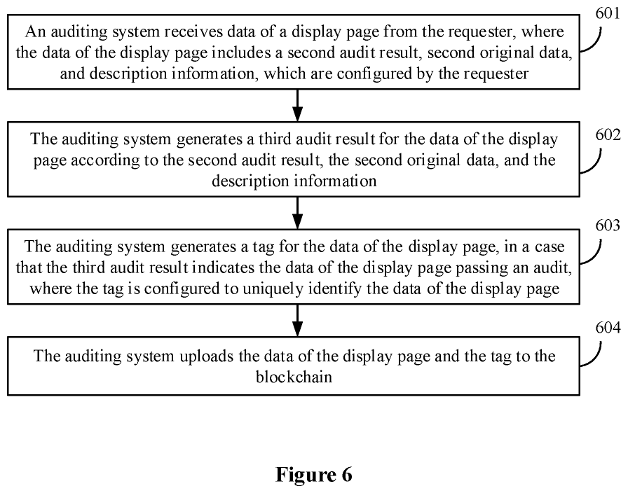

In some scenarios, the auditing system 100 may further audit a display page of the requester on a basis of the foregoing steps S501 to S505, when the requester has a requirement on display. Hereinafter illustration is made in conjunction with a flow chart of the method for auditing data as shown in FIG. 6. The method includes following steps S601 to S604.

In step S601, the auditing system 100 receives data of a display page from the requester. The data of the display page includes a second audit result configured by the requester, second original data configured by the requester, and description information configured by the requester.

The auditing system 100 may receive the display page uploaded by the requester via the GUI, and thereby receives the data of the display page. Details of such process may refer to the foregoing description concerning FIG. 4, and are not repeated herein.

In step S602, the auditing system 100 generates a third audit result for the data of the display page according to the second audit result, the second original data, and the description information.

In some embodiments, the auditing system 100 generates the third audit result for the data of display page according to the second original data and the description information, in a case that the first audit result that is in the blockchain and corresponds to the second original data is in consistent with the second audit result.

Alternatively, the auditing system 100 generates the third audit result for the data of display page according to the second original data and the description information, in a case that the first original data that is in the blockchain and corresponds to the second audit result is in consistent with the second original data.

In other embodiments, the data of the display page further includes a blockchain record configured by the requester. The blockchain record is configured to describe the first original data and the first audit result that have been uploaded to the blockchain. In addition, before generating the third audit result, the auditing system 100 needs to determine that the second original data and the second audit result are consistent with the first original data and the first audit result, respectively, that are described in the blockchain record.

In step S603, the auditing system 100 generates a tag for the data of the display page, in a case that the third audit result indicates the data of the display page passing an audit. The tag is configured to uniquely identify the data of the display page.

The description information may be information for introduction. For example, the description information for a product may be an introduction to the product. The auditing system 100 is further configured to generate a tag for the data of the display page, in response to the third audit result indicating that the data of the display page passes an audit. The tag is configured to uniquely identify the data of the display page. For example, the tag may be a two-dimensional code, a barcode, or the like. The display page may be obtained by scanning the two-dimensional code or the barcode via a terminal device. Since each tag identifies data of a display page uniquely, a quantity of the generated tags is equal to a quantity of the display pages.

In step S604, the auditing system 100 uploads the data of the display page and the tag to the blockchain.

After generating the tag of the data of the display page, the auditing system 100 is required to upload the data of the display page and the tag to the blockchain, in order to provide a strong basis for subsequent verification on the data of the display page.

It should be noted that the above steps S601 to S604 are performed on a basis of the steps S501 to S505.

An apparatus for auditing data based on a blockchain is further provided according to embodiments of the present disclosure. The apparatus includes a receiving module, a processing module and an uploading module.

The receiving module is configured to receive an audit request from a requester, where the audit request includes a type of the requester.

The processing module is configured to: determine an item to be audited, according the type of the requester; and generate an item for display, according to the item to be audited and an item for distraction. The receiving module is further configured to receive first original data, which is inputted by the requester based on the item for display. The processing module is further configured to generate a first audit result according to target data and an audit template, where the target data is in the first original data and corresponds to the item to be audited, and the audit template is generated based on the item to be audited and includes referential data for the item to be audited.

The uploading module is configured to upload the first original data and the first audit result to a blockchain.

In an embodiment, the processing module is configured to: determine a weight for each of multiple candidate items, according to the type of the requester; and determine, among the multiple candidate items, a candidate item having the weight greater than a preset threshold, as the item to be audited.

In an embodiment, the receiving module is further configured to receive data of a display page from the requester, where the data of the display page includes a second audit result, second original data, and description information, which are configured by the requester. The processing module is further configured to: generate a third audit result for the data of the display page according to the second audit result, the second original data, and the description information; and generate a tag for the data of the display page, in response to the third audit result indicating that the data of the display page passes an audit, where the tag is configured to uniquely identify the data of the display page. The uploading module is further configured to upload the data of the display page and the tag to the blockchain.

In an embodiment, the processing module is configured to: generate the third audit result according to the second original data and the description information, in response to the first audit result that is in the blockchain and corresponds to the second original data is consistent with the second audit result; or generate the third audit result according to the second original data and the description information, in response to the first original data that is in the blockchain and corresponds to the second audit result is consistent with the second original data.

In an embodiment, the data of the display page further includes a blockchain record configured by the requester, and the blockchain record is configured to describe the first original data and the first audit result that have been uploaded to the blockchain. The processing module is further configured to: determine that the second original data and the second audit result are consistent with the first original data and the first audit result, respectively, which are described in the blockchain record.

In an embodiment, the receiving module is further configured to receive from the requester a request for data update, where the request includes updated data, and the updated data includes at least one of: data of the display page that is updated, the first original data that is updated, or the second original data that is updated. The processing module is further configured to generate an updated audit result based on the updating data request. The uploading module is further configured to upload the updated audit result and the updated data to the blockchain.

A device for auditing data based on a blockchain is further provided according to embodiments of the present disclosure. The device includes a memory and a processor. The memory is configured to store a computer program and transmit the computer program to the processor. The processor is configured to perform any method described in the above description according to instructions in the computer program.

A computer-readable storage medium is further provided according to embodiments of the present disclosure. The computer-readable storage medium is configured to store computer software instructions. The computer software instructions when executed on a computer configure the computer to perform any method described in the above description.

The embodiments of the present disclosure are described in a progressive manner, and each embodiment places emphasis on the difference from other embodiments. Therefore, one embodiment can refer to other embodiments for the same or similar parts. Since apparatuses disclosed in the embodiments correspond to methods disclosed in the embodiments, the description of the apparatuses is simple, and reference may be made to the relevant part of the methods. The system embodiments as described above are only illustrative, units and modules described as separate components may or may not be physically separated. Some or all of the units and modules may be selected to implement solutions in embodiments of the present disclosure. Those skilled in the art can understand and implement such embodiments of the present disclosure without any creative work.

It should be understood that in this present disclosure, the term “at least one” refers to a quantity equal to one or more, and the term “multiple” refers to a quantity equal to two or more. The term “and/or” are used to describe an association relationship between objects, and indicates three possible relationships. For example, “A and/or B” may indicate a case that there is only A, a case that there is only B, and a case that there are both A and B. In each case, a quantity of A may be one or more, and a quantity of B may be one or more. The symbol “/” generally indicates that a former object and a latter object are associated by an “or” relationship. The term “at least one of” or a similar expression refers to “any combination of”, including any combination consisting of a single item or multiple items. For example, at least one of a, b or c may indicate: a, b, c, a and b, a and c, b and c, or, a and b and c, where a quantity of a, a quantity of b, and a quantity of c each may be one or more.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The foregoing embodiments are only preferred embodiments of the present disclosure, and do not limit the present disclosure in any form. The preferred embodiments according to the disclosure are disclosed above, and are not intended to limit the present disclosure. With the method and technical content disclosed above, those skilled in the art can make some variations and improvements to the technical solutions of the present disclosure, or make some equivalent variations on the embodiments without departing from the scope of technical solutions of the present disclosure. All simple modifications, equivalent variations and improvements made based on the technical essence of the present disclosure without departing the content of the technical solutions of the present disclosure fall within the protection scope of the technical solutions of the present disclosure.

1. A method for auditing data based on a blockchain, comprising:
receiving an audit request from a requester, wherein the audit request comprises a type of the requester;
determining an item to be audited, according to the type of the requester;
generating an item for display, according to the item to be audited and an item for distraction;
receiving first original data, which is inputted by the requester based on the item for display;
generating a first audit result according to target data and an audit template, wherein the target data is in the first original data and corresponds to the item to be audited, and the audit template is generated based on the item to be audited and comprises referential data for the item to be audited; and
uploading the first original data and the first audit result to the blockchain.

2. The method according to claim 1, wherein determining the item to be audited according to the type of the requester comprises:
determining a weight for each of a plurality of candidate items, according to the type of the requester; and
determining, among the plurality of candidate items, a candidate item having the weight greater than a preset threshold, as the item to be audited.

3. The method according to claim 1, further comprising:
receiving data of a display page from the requester, wherein the data of the display page comprises a second audit result, second original data, and description information, which are configured by the requester;
generating a third audit result for the data of the display page according to the second audit result, the second original data, and the description information;
generating a tag for the data of the display page, in response to the third audit result indicating that the data of the display page passes an audit, wherein the tag is configured to uniquely identify the data of the display page; and
uploading the data of the display page and the tag to the blockchain.

4. The method according to claim 3, wherein generating the third audit result for the data of the display page data according to the second audit result, the second original data, and the description information comprises:
generating the third audit result according to the second original data and the description information, in response to the first audit result that is in the blockchain and corresponds to the second original data is consistent with the second audit result; or
generating the third audit result according to the second original data and the description information, in response to the first original data that is in the blockchain and corresponds to the second audit result is consistent with the second original data.

5. The method according to claim 3, wherein:
the data of the display page further comprises a blockchain record configured by the requester, and the blockchain record is configured to describe the first original data and the first audit result that have been uploaded to the blockchain; and
before generating the third audit result for the data of the display page according to the second audit result, the second original data, and the description information, the method further comprises:
determining that the second original data and the second audit result are consistent with the first original data and the first audit result, respectively, which are described in the blockchain record.

6. The method according to claim 1, further comprising:
receiving from the requester a request for data update, wherein the request comprises updated data, and the updated data comprises at least one of: data of the display page that is updated, the first original data that is updated, or the second original data that is updated;
generating an updated audit result based on the updating data request; and
uploading the updated audit result and the updated data to the blockchain.

7-13. (canceled)

14. A computer-readable storage medium, storing computer software instructions, wherein the computer software instructions when executed on a computer configure the computer to perform the method according to claim 1.

15. An apparatus for auditing data based on a blockchain, comprising a memory and a processor, wherein the memory stores computer-readable instructions, and the computer-readable instructions when executed by the processor configures the apparatus to perform:
receiving an audit request from a requester, wherein the audit request comprises a type of the requester;
determining an item to be audited, according to the type of the requester;
generating an item for display, according to the item to be audited and an item for distraction;
receiving first original data, which is inputted by the requester based on the item for display;
generating a first audit result according to target data and an audit template, wherein the target data is in the first original data and corresponds to the item to be audited, and the audit template is generated based on the item to be audited and comprises referential data for the item to be audited; and
uploading the first original data and the first audit result to the blockchain.

16. The apparatus according to claim 15, wherein determining the item to be audited according to the type of the requester comprises:
determining a weight for each of a plurality of candidate items, according to the type of the requester; and
determining, among the plurality of candidate items, a candidate item having the weight greater than a preset threshold, as the item to be audited.

17. The apparatus according to claim 15, the computer-readable instructions when executed by the processor configures the apparatus to further perform:
receiving data of a display page from the requester, wherein the data of the display page comprises a second audit result, second original data, and description information, which are configured by the requester;
generating a third audit result for the data of the display page according to the second audit result, the second original data, and the description information;
generating a tag for the data of the display page, in response to the third audit result indicating that the data of the display page passes an audit, wherein the tag is configured to uniquely identify the data of the display page; and
uploading the data of the display page and the tag to the blockchain.

18. The apparatus according to claim 17, wherein generating the third audit result for the data of the display page data according to the second audit result, the second original data, and the description information comprises:
generating the third audit result according to the second original data and the description information, in response to the first audit result that is in the blockchain and corresponds to the second original data is consistent with the second audit result; or
generating the third audit result according to the second original data and the description information, in response to the first original data that is in the blockchain and corresponds to the second audit result is consistent with the second original data.

19. The apparatus according to claim 17, wherein:
the data of the display page further comprises a blockchain record configured by the requester, and the blockchain record is configured to describe the first original data and the first audit result that have been uploaded to the blockchain; and
before generating the third audit result for the data of the display page according to the second audit result, the second original data, and the description information, the computer-readable instructions when executed by the processor configures the apparatus to perform:
determining that the second original data and the second audit result are consistent with the first original data and the first audit result, respectively, which are described in the blockchain record.

20. The apparatus according to claim 15, wherein the computer-readable instructions when executed by the processor configures the apparatus to further perform:
receiving from the requester a request for data update, wherein the request comprises updated data, and the updated data comprises at least one of: data of the display page that is updated, the first original data that is updated, or the second original data that is updated;
generating an updated audit result based on the updating data request; and
uploading the updated audit result and the updated data to the blockchain.
